(19) United States
(12) Patent Application Publication
(10) Pub. No.: US 2023/0163349 A1
(43) Pub. Date: May 25, 2023

(54) ALL SOLID STATE BATTERY

(71) Applicants: Toru KIDOSAKI, Miyoshi-shi (JP); Heidy VISBAL, Nagoya-shi (JP); Nobuhito NAKAYA, Ichihara-shi (JP)

(72) Inventors: Toru KIDOSAKI, Miyoshi-shi (JP); Heidy VISBAL, Nagoya-shi (JP); Nobuhito NAKAYA, Ichihara-shi (JP)

(73) Assignees: TOYOTA JIDOSHA KABUSHIKI KAISHA, Toyota-shi (JP); IDEMITSU KOSAN CO., LTD., Tokyo (JP)

(21) Appl. No.: 17/987,317

(22) Filed: Nov. 15, 2022

(30) Foreign Application Priority Data
Nov. 25, 2021 (JP) 2021-190908

(51) Int. Cl. H01M 10/0562; H01M 4/38

(52) U.S. Cl. CPC H01M 10/0562; H01M 4/386; H01M 2004/027

(57) ABSTRACT

A main object of the present disclosure is to provide an all solid state battery in which change in restraining pressure caused by expansion and contraction of a Si-based active material can be suppressed. The present disclosure achieves the object by providing an all solid state battery including layers in the order of a cathode active material layer, a solid electrolyte layer, and an anode active material layer, wherein: the anode active material layer includes a Si-based active material and a sulfide solid electrolyte; an average particle size D₅₀ of the Si-based active material is 100 nm or more and 800 nm or less; the sulfide solid electrolyte includes, in a Raman spectroscopy spectrum, a peak in a position of 415 cm⁻¹ or more and 425 cm⁻¹ or less, and a half-value width of the peak is 15.5 cm⁻¹ or more and 20.0 cm⁻¹ or less; a volume ratio of the Si-based active material with respect to a total of the Si-based active material and the sulfide solid electrolyte is 1 volume % or more and 65 volume % or less; and a volume ratio of the sulfide solid electrolyte with respect to the total of the Si-based active material and the sulfide solid electrolyte is 35 volume % or more and 99 volume % or less.

### TECHNICAL FIELD

The present disclosure relates to an all solid state battery.

### BACKGROUND ART

An all solid state battery is a battery including a solid electrolyte layer between a cathode active material layer and an anode active material layer, and one of the advantages thereof is that the simplification of a safety device may be more easily achieved compared to a liquid-based battery including a liquid electrolyte containing a flammable organic solvent.

Patent Literature 1 discloses an anode active material for secondary battery comprising a Si-oxide solid electrolyte composite including a matrix configured by an amorphous or low crystalline oxide solid electrolyte, and a Si nano particle dispersed in the matrix.

### CITATION LIST

### Patent Literature

Patent Literature 1: Japanese Patent Application Laid-Open (JP-A) No. 2013-239267

### SUMMARY OF DISCLOSURE

### Technical Problem

Although the capacity properties of the Si-based active material are well, the volume change thereof due to charge and discharge tends to be large. When such a Si-based active material is used as an anode active material for all solid state battery, a cut-off of path (cut-off of ion conducting path and electron conducting path) in an anode active material layer occurs along with charge and discharge of a battery, and as a result, battery performance may be deteriorated. Also, a restraining pressure is usually applied to an all solid state battery in order to obtain excellent battery performance, but from the viewpoint of inhibiting the cut-off of path, the change in the restraining pressure caused by expansion and contraction of the Si-based active material is desired to be small.

The present disclosure has been made in view of the above circumstances, and a main object thereof is to provide an all solid state battery in which change in restraining pressure caused by expansion and contraction of a Si-based active material can be suppressed.

### Solution to Problem

In order to achieve the object, the present disclosure provides an all solid state battery including a cathode active material layer, an anode active material layer, and a solid electrolyte layer arranged between the cathode active material layer and the anode active material layer, wherein: the anode active material layer includes a Si-based active material and a sulfide solid electrolyte; an average particle size D₅₀ of the Si-based active material is 100 nm or more and 800 nm or less; the sulfide solid electrolyte includes, in a Raman spectroscopy spectrum, a peak in a position of 415 cm⁻¹ or more and 425 cm⁻¹ or less, and a half-value width of the peak is 15.5 cm⁻¹ or more and 20.0 cm⁻¹ or less; a volume ratio of the Si-based active material with respect to a total of the Si-based active material and the sulfide solid electrolyte is 1 volume % or more and 65 volume % or less; and a volume ratio of the sulfide solid electrolyte with respect to the total of the Si-based active material and the sulfide solid electrolyte is 35 volume % or more and 99 volume % or less.

According to the present disclosure, the anode active material layer includes the Si-based active material with the specified average particle size, and the sulfide solid electrolyte with low crystallinity specified from the peak of the Raman spectroscopy spectrum, in the specified ratio, and thus the all solid state battery in which change in restraining pressure caused by expansion and contraction of the Si-based active material can be suppressed, may be achieved.

In the present disclosure, the sulfide solid electrolyte may contain a PS₄³⁻ structure; and the peak may be a peak of the PS₄³⁻ structure.

In the disclosure, the sulfide solid electrolyte may contain at least Li, P, and S.

In the disclosure, the sulfide solid electrolyte may contain a halogen.

In the disclosure, a lithium ion conductivity of the sulfide solid electrolyte at 25° C. may be 1.5 mS/cm or more and 3.5 mS/cm or less.

### Advantageous Effects of Disclosure

The all solid state battery in the present disclosure exhibits an effect of suppressing the change in restraining pressure caused by expansion and contraction of a Si-based active material.

### BRIEF DESCRIPTION OF DRAWINGS

FIG. 1 is a schematic cross-sectional view exemplifying the all solid state battery in the present disclosure.

FIG. 2 is a graph showing the results of changes in restraining pressure in Examples 1 to 12.

FIG. 3 is a graph showing the results of changes in restraining pressure in Comparative Examples 1 to 14.

FIG. 4 is a graph showing the results of changes in restraining pressure in Example 10 and Comparative Example 14.

### DESCRIPTION OF EMBODIMENTS

The all solid state battery in the present disclosure is hereinafter explained in details with reference to drawings. Each drawing described as below is a schematic view, and the size and the shape of each portion are appropriately exaggerated in order to be understood easily. Further, in each drawing, hatchings or reference signs are appropriately omitted. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

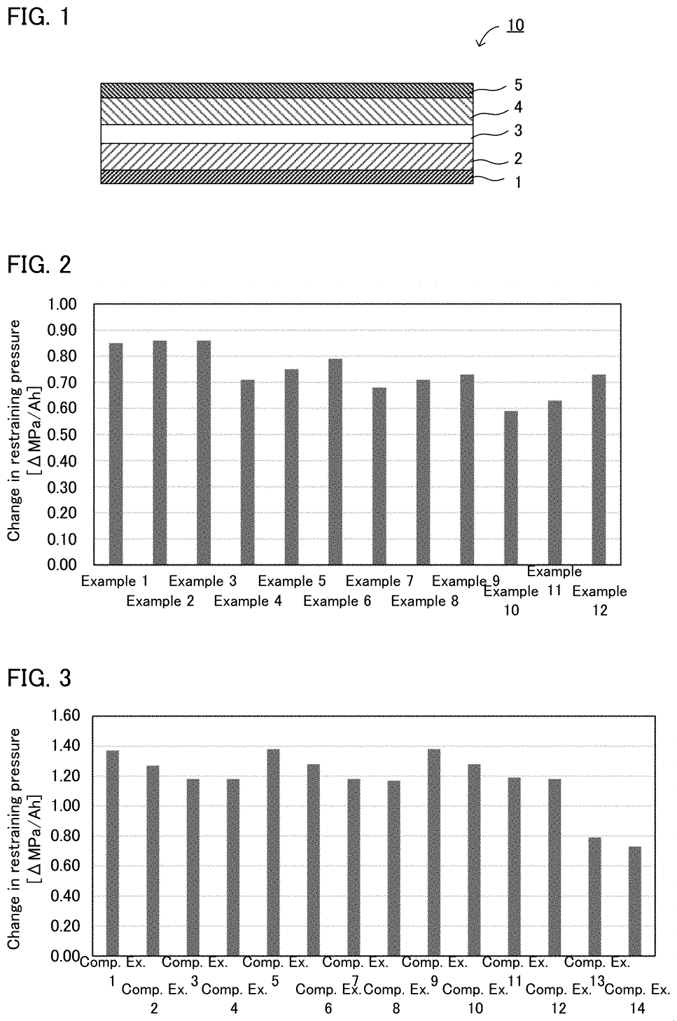

FIG. 1 is a schematic cross-sectional view exemplifying the all solid state battery in the present disclosure. All solid state battery 10 shown in FIG. 1 includes layers in the order of: anode current collector 1, anode active material layer 2, solid electrolyte layer 3, cathode active material layer 4, and cathode current collector 5. In the present disclosure, the anode active material layer 2 contains the later described Si-based active material and sulfide solid electrolyte in the specified ratio.

According to the present disclosure, the anode active material layer includes the Si-based active material with the specified average particle size, and the sulfide solid electrolyte with low crystallinity specified from the peak of the Raman spectroscopy spectrum, in the specified ratio, and thus the all solid state battery in which change in restraining pressure caused by expansion and contraction of the Si-based active material can be suppressed, may be achieved. Here, the sulfide solid electrolyte includes a peak in the specified position in the Raman spectroscopy spectrum obtained by the Raman spectroscopy measurement. Further, the half-value width of the specified peak is in the specified range. The half-value width of the Raman spectroscopy spectrum relates to crystallinity of the sulfide solid electrolyte, and the lower the crystallinity is, the larger the half-value width becomes. In the description, the sulfide solid electrolyte including a peak in a position of 415 cm⁻¹ or more and 425 cm⁻¹ or less, and a half-value width of the peak being 15.5 cm⁻¹ or more and 20.0 cm⁻¹ or less, is also referred to as a “low crystalline sulfide solid electrolyte”.

In the low crystalline sulfide solid electrolyte, the ratio of the crystal phase is lower than that in a high crystalline sulfide solid electrolyte, and thus capable of following the expansion and contraction of the Si-based active material. As a result, when the Si-based active material expands and contracts, the volume change in the entire anode active material layer may be decreased, and change in restraining pressure may be suppressed. Further, since the Si-based active material in the present disclosure has small average particle size, change in restraining pressure may be further suppressed.

1. Anode

The anode in the present disclosure includes an anode active material layer and an anode current collector. The anode active material layer contains a Si-based active material with the specified average particle size (D₅₀) as the anode active material, and the specified sulfide solid electrolyte. Also, the anode active material layer may further contain at least one of a conductive material and a binder.

(1) Si-Based Active Material

The anode active material layer includes a Si-based active material. The Si-based active material is an active material containing a Si element. Examples of the Si-based active material may include a simple substance of Si, a Si alloy and a Si oxide. The Si alloy preferably contains a Si element as a main component.

The shape of the Si-based active material is usually a granular shape. The average particle size (D₅₀) of the Si-based active material is usually 100 nm or more, may be 400 nm or more, and may be 470 nm or more. Meanwhile, the average particle size (D₅₀) of the Si-based active material is usually 800 nm or less, may be 700 nm or less, and may be 630 nm or less. If the average particle size (D₅₀) of the Si-based active material is too large, the effect of suppressing the change in restraining pressure may not be easily obtained. The average particle size (D₅₀) may be calculated from, for example, a measurement with a laser diffraction particle distribution meter or a scanning electron microscope (SEM).

In the anode active material layer, the volume ratio of the Si-based active material with respect to the total of the Si-based active material and the low crystalline sulfide solid electrolyte is usually 1 volume % or more, may be 20 volume % or more, and may be 50 volume % or more. Meanwhile, the volume ratio of the Si-based active material is usually 65 volume % or less, may be 60 volume % or less, and may be 55 volume % or less. If the volume ratio of the Si-based active material is too large, the effect of suppressing the change in restraining pressure may not be easily obtained.

The proportion of the anode active material in the anode active material layer is, for example, 20 weight % or more, may be 40 weight % or more and may be 60 weight % or more. Meanwhile, the proportion of the anode active material is, for example, 80 weight % or less.

(2) Low Crystalline Sulfide Solid Electrolyte

The anode active material layer in the present disclosure contains a sulfide solid electrolyte with low crystallinity specified from a peak of a Raman spectroscopy spectrum. The low crystalline sulfide solid electrolyte includes, in a Raman spectroscopy spectrum, a peak in a position of 415 cm⁻¹ or more and 425 cm⁻¹ or less. This peak is a peak derived from a PS₄³⁻ structure included in the low crystalline sulfide solid electrolyte.

The half-value width of the peak (full-width half-maximum, FWHM) is usually 15.5 cm⁻¹ or more, may be 16.0 cm⁻¹ or more, may be 16.5 cm⁻¹ or more, and may be 17.0 cm⁻¹ or more. If the half-value width is too small, the effect of suppressing change in restraining pressure may not be easily obtained. Meanwhile, the half-value width of the peak is usually 20.0 cm⁻¹ or less and may be 18.0 cm⁻¹ or less. If the half-value width is too large, ion conductivity may be easily degraded. As a device of the Raman spectroscopy analysis, commercially available Raman spectroscopy meters (such as NRS-3100 from JASCO Corporation) may be used. Preferable examples of the measurement conditions may include, excitation laser wavelength of 532 nm, resolution of 4 cm⁻¹, attenuation rate of 0.6, and exposure time of 120 seconds. Also, the measurement time is, for example, about five times.

The low crystalline sulfide solid electrolyte contains a PS₄⁻³ structure. The low crystalline sulfide solid electrolyte preferably contains the PS₄³⁻ structure as a main component of an anion structure including P and S (such as PS₄³⁻ structure, P₂S₆⁴⁻ structure, and P₂S₇⁴⁻ structure). The proportion of the PS₄³⁻ structure with respect to all the anion structures including P and S in the low crystalline sulfide solid electrolyte is, for example, 50 mol % or more, may be 70 mol % or more, and may be 90 mol % or more.

It is preferable that the low crystalline sulfide solid electrolyte contains at least Li, P, and S. The low crystalline sulfide solid electrolyte may further contain a halogen such as F, Cl, Br and I. Among them, the low crystalline sulfide solid electrolyte preferably further contains at least one of Br and I.

The low crystalline sulfide solid electrolyte may have a composition represented by xLiI.yLiBr.z(αLi₂S.1−α)P₂S₅). Here, it is x+y+z=100, 0≤x<100, 0≤y<100, 0<z≤100, and 0.70≤α≤0.80. The “x” may be larger than 0. In this case, the “x” may be 5 or more, and may be 10 or more. Also, the “x” may be 50 or less, and may be 30 or less. Also, the “y” may be larger than 0. In this case, the “y” may be 5 or more, and may be 10 or more. Also, the “y” may be 50 or less, and may be 30 or less. The “z” may be 50 or more, and may be 60 or more. The “a” may be 0.72 or more, and may be 0.74 or more. Meanwhile, the “α” may be 0.78 or less, and may be 0.76 or less.

The low crystalline sulfide solid electrolyte may or may not contain O. In the former case, the proportion of O included in the low crystalline sulfide solid electrolyte is preferably smaller than the proportion of S included in the low crystalline sulfide solid electrolyte.

The low crystalline sulfide solid electrolyte may include a crystal phase A that has peaks at the positions of 2θ=20.20±0.5° and 23.60±0.50 in an X-ray diffraction measurement using a Cu-Kα ray. The crystal phase A is a crystal phase with high Li ion conductivity. The crystal phase A may include peaks at the positions of 2θ=29.4°±0.50, 37.80±0.50, 41.10±0.50, and 47.00±0.5°, depending on its crystallinity.

The low crystalline sulfide solid electrolyte preferably does not include a crystal phase B that has peaks at the positions of 2θ=21.0°±0.5° and 28.0°±0.5° in an X-ray diffraction measurement using a Cu-Kα ray. The crystal phase B is a crystal phase with lower Li ion conductivity than that of the crystal phase A. The crystal phase B may include peaks at the positions of 2θ=32.0°±0.5°, 33.4°±0.5°, 38.7°±0.5°, 42.8°±0.5°, and 44.2°±0.5° depending on its crystallinity.

Also, the peak intensity of 2θ=20.2°±0.5° is regarded as I_{20.2}, and the peak intensity of 2θ=21.0°±0.5° is regarded as I_{21.0}. I_{21.0}/I_{20.2} is, for example, 0.4 or less, may be 0.2 or less, may be 0.1 or less, and may be 0.

The lithium ion conductivity of the low crystalline sulfide solid electrolyte at 25° C. is, for example, 1.5 mS/cm or more, may be 2.0 mS/cm or more, and may be 2.4 mS/cm or more. Meanwhile, the lithium ion conductivity is, for example, 3.5 mS/cm or less, and may be 3.2 mS/cm or less.

The shape of the low crystalline sulfide solid electrolyte in the present disclosure is usually a granular shape. The average particle size (D₅₀) of the low crystalline sulfide solid electrolyte is, for example, 40 μm or less, may be 10 μm or less, and may be 5 μm or less. Meanwhile, the average particle size is, for example, 0.01 μm or more and may be 0.1 μm or more.

The volume ratio of the low crystalline sulfide solid electrolyte with respect to the total of the Si-based active material and the low crystalline sulfide solid electrolyte in the anode active material layer is usually 35 volume % or more, may be 40 volume % or more, and may be 45 volume % or more. If the volume ratio of the low crystalline sulfide solid electrolyte is too small, the effect of suppressing change in restraining pressure may not be easily obtained. Meanwhile, the volume ratio of the low crystalline sulfide solid electrolyte is, usually 99 volume % or less, may be 80 volume % or less, and may be 60 volume % or less.

The proportion of the low crystalline sulfide solid electrolyte in the anode active material layer is, for example, 20 weight % or more, may be 40 weight % or more and may be 60 weight % or more. Meanwhile, the proportion of the low crystalline sulfide solid electrolyte is, for example, 80 weight % or less.

The low crystalline sulfide solid electrolyte may be produced by heat treating an amorphous precursor. The amorphous precursor may be obtained by, for example, conducting an amorphizing treatment to a raw material composition. It is preferable that the raw material composition contains, for example, Li₂S and P₂S₅. The raw material composition may further contain one kind or two kinds or more of LiX (X is halogen). Examples of the amorphizing treatment may include mechanical milling and a melting and quenching method.

Also, to the amorphous precursor, a refining treatment may be conducted before conducting the heat treatment. In the refining treatment, it is preferable to conduct wet crushing using a dispersion medium. Examples of the dispersion medium may include ethers and a mixture dispersion medium including ethers. Examples of the ethers may include chain ethers such as dibutyl ether, diethyl ether, and dimethyl ether, and cyclic ethers such as tetrahydrofuran. Examples of the crushing method may include bead milling and planetary ball milling.

By heat treating the amorphous precursor, the crystallization of the sulfide solid electrolyte is conducted as well as the low crystalline sulfide solid electrolyte is produced. The heating temperature is, for example, 120° C. or more and may be 150° C. or more. Meanwhile, it is, for example, 180° C. or less. The heat treatment time is, for example, 3 hours or more and 5 hours or less. The heating atmosphere is preferably a reduced pressure atmosphere (such as 500 Pa or less). As the means of heating, general burning furnace may be used.

(3) Anode

The anode active material layer may contain a conductive material. Examples of the conductive material may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF).

The anode active material layer may contain a binder. Examples of the binder may include a fluoride-based binder, a polyimide-based binder and a rubber-based binder.

Examples of the method for forming the anode active material layer may include a method such that slurry containing a Si-based active material, the low crystalline sulfide solid electrolyte, and a dispersion medium is produced, and the slurry is pasted on the anode current collector and dried. There are no particular limitations on the method for pasting the slurry, and known arbitrary pasting methods can be used.

The anode current collector is a layer that collects currents of the anode active material layer. Examples of the anode current collector may include SUS, copper, nickel, and carbon. Examples of the shape of the anode current collector may include a foil shape.

2. Cathode

The cathode in the present disclosure includes a cathode active material layer and a cathode current collector. The cathode active material layer is a layer containing at least a cathode active material. Also, the cathode active material layer may contain at least one of a solid electrolyte, a conductive material, and a binder, as required.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂ and Li(Ni_{0.5}Mn_{1.5})O₄; and an olivine type active material such as LiFePO₄, LiMnPO₄, LiNiPO₄, and LiCoPO₄.

A protective layer containing a Li-ion conductive oxide may be formed on the surface of the oxide active material. The reason therefor is to inhibit the reaction of the oxide active material and the solid electrolyte. Examples of the Li-ion conductive oxide may include LiNbO₃. The thickness of the protective layer is, for example, 1 nm or more and 30 nm or less. Also, as the cathode active material, for example, Li₂S can be used.

Examples of the shape of the cathode active material may include a granular shape. The average particle size (D₅₀) of the cathode active material is not particularly limited, and for example, it is 10 nm or more, and may be 100 nm or more. Meanwhile, the average particle size (D₅₀) of the cathode active material is, for example, 50 μm or less, and may be 20 μm or less.

The conductive material and the binder to be used in the cathode active material layer are in the same contents as those described in “1. Anode” above; thus, the descriptions herein are omitted. The solid electrolyte to be used in the cathode active material layer is in the same contents as those described in “3. Solid electrolyte layer” later; thus, the descriptions herein are omitted. The thickness of the cathode active material layer is, for example, 0.1 μm or more and 1000 μm or less.

The cathode current collector is a layer that collects currents of the cathode active material layer. Examples of the cathode current collector may include SUS, aluminum, nickel, iron, titanium, and carbon. Examples of the shape of the cathode current collector may include a foil shape.

3. Solid Electrolyte Layer

The solid electrolyte layer in the present disclosure is a layer arranged between the cathode active material layer and the anode active material layer, and contains at least a solid electrolyte. Examples of the solid electrolyte may include an inorganic solid electrolyte such as a sulfide solid electrolyte, an oxide solid electrolyte, a nitride solid electrolyte, and a halide solid electrolyte. The solid electrolyte layer preferably contains a sulfide solid electrolyte as the solid electrolyte. When the sulfide solid electrolyte is used, it may be the above described low crystalline sulfide solid electrolyte, and may be a sulfide solid electrolyte other than the above described low crystalline sulfide solid electrolyte.

The sulfide solid electrolyte included in the solid electrolyte layer usually includes a Li element and a S element. Further, the sulfide solid electrolyte preferably contains at least one kind of a P element, a Ge element, a Sn element, and a Si element. Also, the sulfide solid electrolyte may contain at least one kind of an O element and a halogen element (such as a F element, a Cl element, a Br element, and an I element).

Examples of the sulfide solid electrolyte included in the solid electrolyte layer may include Li₂S—P₂S₅, Li₂S—P₂S₅—GeS₂, Li₂S—P₂S₅—SnS₂, Li₂S—P₂S₅—SiS₂, Li₂S—P₂S₅—LiI, Li₂S—P₂S₅—LiI—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n is a positive number; Z is any one of Ge, Zn, and Ga), Li₂S—GeS₂, Li₂S—SiS₂—Li₃PO₄, and Li₂S—SiS₂-LiₓMO_{y} (provided that x and y is a positive number; M is any one of P, Si, Ge, B, Al, Ga, and In). Incidentally, the description “Li₂S—P₂S₅” above means a material configured by a raw material composition including Li₂S and P₂S₅, and the other descriptions are in the same manners.

The solid electrolyte included in the solid electrolyte layer may be glass, may be glass ceramic, and may be a crystal material. Glass may be obtained by conducting an amorphizing treatment to a raw material composition (such as a mixture of Li₂S and P₂S₅). Examples of the amorphizing treatment may include mechanical milling. The mechanical milling may be dry mechanical milling and may be wet mechanical milling, but the latter is preferable. The reason therefor is to prevent the raw material mixture from adhering to wall such as a container. Also, the glass ceramic may be obtained by performing a heat treatment to glass. Also, the crystal material may be obtained by, for example, conducting a solid phase reaction treatment to the raw material composition.

The shape of the solid electrolyte included in the solid electrolyte layer is preferably in a granular shape. Also, the average particle size (D₅₀) of the solid electrolyte is, for example, 0.01 μm or more. Meanwhile, the average particle size (D₅₀) of the solid electrolyte is, for example, 10 μm or less, and may be 5 μm or less. Li ion conductivity of the solid electrolyte at 25° C. is, for example, 1*10⁻⁴ S/cm or more, and is preferably 1*10⁻³ S/cm or more.

The content of the solid electrolyte in the solid electrolyte layer is, for example 70 weight % or more and may be 90 weight % or more. The solid electrolyte layer may contain a binder as required. The binder is in the same contents as those described in “1. Anode” above; thus, the descriptions herein are omitted. Also, the thickness of the solid electrolyte layer is, for example, 0.1 μm or more. Meanwhile, the thickness of the solid electrolyte layer is, for example, 300 μm or less, and may be 100 μm or less.

4. All Solid State Battery

The all solid state battery in the present disclosure comprises at least one of a power generating unit including a cathode active material layer, a solid electrolyte layer and an anode active material layer, and may comprise two or more of the unit. When the all solid state battery comprises a plurality of the power generating unit, they may be connected in parallel and may be connected in series. The all solid state battery in the present disclosure includes an outer package for storing the cathode, the solid electrolyte layer, and the anode. There are no particular limitations on the kind of the outer package, and examples thereof may include a laminate outer package. Also, it is preferable that the all solid state battery does not contain a liquid electrolyte.

The all solid state battery in the present disclosure may include a restraining jig that applies a restraining pressure along with the thickness direction of the cathode, the solid electrolyte layer and the anode. Excellent ion conducting path and electron conducting path may be formed by applying the restraining pressure. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

The all solid state battery in the present disclosure is typically an all solid lithium ion secondary battery. The application of the all solid state battery is not particularly limited, and examples thereof may include a power source for vehicles such as hybrid electric vehicles, battery electric vehicles, gasoline-fueled automobiles and diesel powered automobiles. In particular, it is preferably used as a power source for driving hybrid electric vehicles and battery electric vehicles. Also, the all solid state battery in the present disclosure may be used as a power source for moving bodies other than vehicles (such as rail road transportation, vessel and airplane), and may be used as a power source for electronic products such as information processing equipment.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Production Example

<Production of Sulfide Solid Electrolyte 1>

A raw material composition including Li₂S, P₂S₅, LiBr, and LiI was amorphized by mechanical milling, and thereby an amorphous precursor with the composition 15LiBr-10LiI-75(0.75Li₂S-0.25P₂S₅) was obtained.

To a bead mill (LMZ015 from Ashizawa Finetech Ltd.), 6 kg of ZrO₂ balls (φ0.2 mm) were added, the precursor with the composition 15LiBr-10LiI-75(0.75Li₂S-0.25P₂S₅), dehydrated heptane, and dibutyl ether were added to an agitation tank, and crushing was conducted at the speed of 16 m/s for 1 hour, then at the speed of 9 m/s for 7 hours to obtain slurry (refining step). The obtained slurry was vacuum-dried at 120° C. for 3 hours. After that, a heat treatment was conducted under vacuum of 500 Pa or less, at 180° C. for 3 hours (heat treatment step). Thereby, a sulfide solid electrolyte layer 1 was obtained.

<Production of Sulfide Solid Electrolyte 2>

A sulfide solid electrolyte 2 was obtained in the same manners as for the sulfide solid electrolyte 1, except that the heat treatment step was conducted by heating under vacuum of 500 Pa or less, at 150° C. for 5 hours.

<Production of Sulfide Solid Electrolyte 3>

A sulfide solid electrolyte 3 was obtained in the same manners as for the sulfide solid electrolyte 1, except that the heat treatment step was conducted by heating under vacuum of 500 Pa or less, at 120° C. for 5 hours.

<Production of Sulfide Solid Electrolyte 4>

A sulfide solid electrolyte 4 was obtained in the same manners as for the sulfide solid electrolyte 1, except that the heat treatment step was conducted by heating under vacuum of 500 Pa or less, at 200° C. for 5 hours.

[Evaluation]

The Raman spectroscopy spectrum of the obtained sulfide solid electrolytes 1 to 4 was respectively measured, and the peak position and the half-value width were respectively obtained. The results are shown in Table 1.

TABLE 1

| | Peak position (cm⁻¹) | Half-value width (cm⁻¹) |
|---|---|---|
| Sulfide solid electrolyte 1 | 417.5 | 16.5 |
| Sulfide solid electrolyte 2 | 418.6 | 17.1 |
| Sulfide solid electrolyte 3 | 420.0 | 17.9 |
| Sulfide solid electrolyte 4 | 416.2 | 15.2 |

As shown in Table 1, in all the sulfide solid electrolytes 1 to 4, the peaks were confirmed in the position of 415 cm⁻¹ or more and 425 cm⁻¹ or less. Also, in all the sulfide solid electrolytes 1 to 3, the half-value width of the peak was respectively 15.5 cm⁻¹ or more. In contrast, the half-value width of the peak in the sulfide solid electrolyte 4 was less than 15.5 cm⁻¹.

### Example 1

<Production of Anode>

Weighed were 22.1 g of an anode active material (Si particle) that was a nano material, 11.3 g of a sulfide solid electrolyte (the sulfide solid electrolyte 1), and 2.9 g of a conductive material (VGCF). Also, a binder (PVDF) diluted to 5 weight % and a dispersion medium (diisobutyl ketone, DIBK) were prepared.

These were put into a kneading device (FILMIX™, from PRIMIX Corporation), and kneaded in the speed range of 5 m/s to 30 m/s to obtain slurry of which solid component was 39 weight %. The mixture volume ratio (Si particle:sulfide solid electrolyte 1) of the Si particle and the sulfide solid electrolyte 1 corresponded to 65:35. The obtained slurry was pasted on an anode current collector (Ni foil) and dried, to obtain an anode including an anode active material layer and an anode current collector.

<Production of Solid Electrolyte Layer>

A sulfide solid electrolyte (the sulfide solid electrolyte 4) was weighed to be 39.0 g. Also, a binder (PVDF) diluted to 5 weight % and a dispersion medium (mixture of heptane and dibutyl ether) were prepared. These were mixed by a kneading device (barrel kneading machine) at 2000 rpm to obtain slurry for solid electrolyte layer of which solid component was 50 weight %. The obtained slurry for solid electrolyte layer was pasted on an Al foil and dried to obtain a solid electrolyte layer formed on the Al foil.

<Production of Cathode>

A cathode active material (LiNi_{1/3}Co_{1/3}Mn_{1/3}O₂), a dispersion medium (butyl butyrate), a binder (5 weight % butyl butyrate solution that was PVdF-based binder), a sulfide solid electrolyte (the sulfide solid electrolyte 4) and a conductive material (VGCF) were mixed to obtain slurry. The obtained slurry was pasted on a cathode current collector (Al foil) and dried to obtain a cathode including a cathode active material layer and a cathode current collector.

<Production of Evaluation Cell>

The solid electrolyte layer and the cathode active material layer were layered so that the solid electrolyte layer contacted the cathode active material layer, and then pressed. Then, a substrate (Al foil) of the solid electrolyte layer was peeled off, the solid electrolyte layer and the anode active material layer were layered so that the solid electrolyte layer contacted the anode active material layer, and then pressed. Thereby, an evaluation cell was produced.

### Examples 2 and 3

An evaluation cell was respectively produced in the same manner as in Example 1, except that the Si particle and the sulfide solid electrolyte in the anode active material layer were changed to the contents shown in Table 2.

### Example 4

Weighed were 22.1 g of an anode active material (Si particle) that was a nano material, 14.0 g of a sulfide solid electrolyte (the sulfide solid electrolyte 1), and 2.9 g of a conductive material (VGCF). Also, a binder, a dispersant and a dispersion medium were prepared in the same manner as in Example 1. These were put into a kneading device (FILMIX™, from PRIMIX Corporation), and kneaded in the speed range of 5 m/s to 30 m/s to obtain slurry of which solid component was 39 weight %. The mixture volume ratio (Si particle:sulfide solid electrolyte 1) of the Si particle and the sulfide solid electrolyte 1 corresponded to 60:40. The obtained slurry was pasted on an anode current collector (Cu foil) and dried to obtain an anode including an anode active material layer and an anode current collector. An evaluation cell was obtained in the same manner as in Example 1 except that the obtained anode was used.

### Examples 5 and 6

An evaluation cell was respectively produced in the same manner as in Example 4, except that the Si particle and the sulfide solid electrolyte in the anode active material layer were changed to the contents shown in Table 2.

### Example 7

Weighed were 22.1 g of an anode active material (Si particle) that was a nano material, 17.2 g of a sulfide solid electrolyte (the sulfide solid electrolyte 1), and 2.9 g of a conductive material (VGCF). Also, a binder, a dispersant and a dispersion medium were prepared in the same manner as in Example 1. These were put into a kneading device (FILMIX™, from PRIMIX Corporation), and kneaded in the speed range of 5 m/s to 30 m/s to obtain slurry of which solid component was 39 weight %. The mixture volume ratio (Si particle:sulfide solid electrolyte 1) of the Si particle and the sulfide solid electrolyte 1 corresponded to 55:45. The obtained slurry was pasted on an anode current collector (Cu foil) and dried to obtain an anode including an anode active material layer and an anode current collector. An evaluation cell was obtained in the same manner as in Example 1 except that the obtained anode was used.

### Examples 8 and 9

An evaluation cell was respectively produced in the same manner as in Example 7, except that the Si particle and the sulfide solid electrolyte in the anode active material layer were changed to the contents shown in Table 2.

### Example 10

Weighed were 22.1 g of an anode active material (Si particle) that was a nano material, 21.0 g of a sulfide solid electrolyte (the sulfide solid electrolyte 1), and 2.9 g of a conductive material (VGCF). Also, a binder, a dispersant and a dispersion medium were prepared in the same manner as in Example 1. These were put into a kneading device (FILMIX™, from PRIMIX Corporation), and kneaded in the speed range of 5 m/s to 30 m/s to obtain slurry of which solid component was 39 weight %. The mixture volume ratio (Si particle:sulfide solid electrolyte 1) of the Si particle and the sulfide solid electrolyte 1 corresponded to 50:50. The obtained slurry was pasted on an anode current collector (Cu foil) and dried to obtain an anode including an anode active material layer and an anode current collector. An evaluation cell was obtained in the same manner as in Example 1 except that the obtained anode was used.

### Examples 11 and 12

An evaluation cell was respectively produced in the same manner as in Example 10, except that the Si particle and the sulfide solid electrolyte in the anode active material layer were changed to the contents shown in Table 2.

### Comparative Examples 1 to 12

A Si particle that was not a nano material was prepared. Further, the sulfide solid electrolytes 1 to 3 were prepared. Also, a binder, a dispersant and a dispersion medium were prepared in the same manner as in Example 1. These were put into a kneading device (FILMIX™, from PRIMIX Corporation), and kneaded in the speed range of 5 m/s to 30 m/s to obtain slurry of which solid component was 53 weight %. The kind of the sulfide solid electrolyte, and the mixture volume ratio of the Si particle and the sulfide solid electrolyte in the slurry were respectively as shown in Table 3. The obtained slurry was pasted on an anode current collector (Cu foil) and dried to obtain an anode including an anode active material layer and an anode current collector. An evaluation cell was respectively obtained in the same manner as in Example 1 except that the obtained anode was used.

### Comparative Examples 13 and 14

A Si particle that was a nano material was prepared. Further, the sulfide solid electrolyte 4 was prepared. Also, a binder, a dispersant and a dispersion medium were prepared in the same manner as in Example 1. These were put into a kneading device (FILMIX™, from PRIMIX Corporation), and kneaded in the speed range of 5 m/s to 30 m/s to obtain slurry of which solid component was 39 weight %. The mixture volume ratio of the Si particle and the sulfide solid electrolyte in the slurry was respectively as shown in Table 3. The obtained slurry was pasted on an anode current collector (Cu foil) and dried to obtain an anode including an anode active material layer and an anode current collector. An evaluation cell was respectively obtained in the same manner as in Example 1 except that the obtained anode was used.

[Evaluation]

<Evaluation of Change in Restraining Pressure>

CCCV-charge and discharge were respectively conducted to the obtained evaluation cells in the range of upper limit voltage of 4.05 V to lower limit voltage of 2.5 V, at 0.1 C for 4 cycles. The designed capacity of the solid battery was 0.4 Ah. To the pressure meter of a cell restraining jig, NR600 data logger (from KEYENCE) was connected, and the changes in pressure of the cells were respectively measured. The change in restraining pressure was calculated from the below calculation formula. The results of changes in restraining pressure at the time of initially fully charged are shown in Table 2, Table 3, FIG. 2, and FIG. 3.

Change in restraining pressure (ΔMPa/Ah)=change in pressure (ΔMPa)/Charge capacity (Ah)

TABLE 2

| | Si | | | Active | Change in |
|---|---|---|---|---|---|
| | particle | | Ion | material:Solid | restraining |
| | size | | conductivity | electrolyte | pressure |
| | [nm] | Sulfide solid electrolyte | [mS/cm] | (Volume ratio) | [ΔMPa/Ah] |
| Example 1 | 470 | Sulfide solid electrolyte 1 | 3.2 | 65:35 | 0.85 |
| Example 2 | 510 | Sulfide solid electrolyte 2 | 2.4 | 65:35 | 0.86 |
| Example 3 | 630 | Sulfide solid electrolyte 3 | 2.0 | 65:35 | 0.86 |
| Example 4 | 470 | Sulfide solid electrolyte 1 | 3.2 | 60:40 | 0.71 |
| Example 5 | 510 | Sulfide solid electrolyte 2 | 2.4 | 60:40 | 0.75 |
| Example 6 | 630 | Sulfide solid electrolyte 3 | 2.0 | 60:40 | 0.79 |
| Example 7 | 470 | Sulfide solid electrolyte 1 | 3.2 | 55:45 | 0.68 |
| Example 8 | 500 | Sulfide solid electrolyte 2 | 2.4 | 55:45 | 0.71 |
| Example 9 | 630 | Sulfide solid electrolyte 3 | 2.0 | 55:45 | 0.73 |
| Example 10 | 470 | Sulfide solid electrolyte 1 | 3.2 | 50:50 | 0.59 |
| Example 11 | 500 | Sulfide solid electrolyte 2 | 2.4 | 50:50 | 0.63 |
| Example 12 | 630 | Sulfide solid electrolyte 3 | 2.0 | 50:50 | 0.73 |

TABLE 3

| | Si | | | Active | Change in |
|---|---|---|---|---|---|
| | particle | | Ion | material:Solid | restraining |
| | size | | conductivity | electrolyte | pressure |
| | [nm] | Sulfide solid electrolyte | [mS/cm] | (Volume ratio) | [ΔMPa/Ah] |
| Comp. Ex. 1 | 2700 | Sulfide solid electrolyte 1 | 3.2 | 65:35 | 1.37 |
| Comp. Ex. 2 | 2700 | Sulfide solid electrolyte 1 | 3.2 | 60:40 | 1.27 |
| Comp. Ex. 3 | 2700 | Sulfide solid electrolyte 1 | 3.2 | 55:45 | 1.18 |
| Comp. Ex. 4 | 2700 | Sulfide solid electrolyte 1 | 3.2 | 50:50 | 1.18 |
| Comp. Ex. 5 | 2700 | Sulfide solid electrolyte 2 | 2.4 | 65:35 | 1.38 |
| Comp. Ex. 6 | 2700 | Sulfide solid electrolyte 2 | 2.4 | 60:40 | 1.28 |
| Comp. Ex. 7 | 2700 | Sulfide solid electrolyte 2 | 2.4 | 55:45 | 1.18 |
| Comp. Ex. 8 | 2700 | Sulfide solid electrolyte 2 | 2.4 | 50:50 | 1.17 |
| Comp. Ex. 9 | 2700 | Sulfide solid electrolyte 3 | 2.0 | 65:35 | 1.38 |
| Comp. Ex. 10 | 2700 | Sulfide solid electrolyte 3 | 2.0 | 60:40 | 1.28 |
| Comp. Ex. 11 | 2700 | Sulfide solid electrolyte 3 | 2.0 | 55:45 | 1.19 |
| Comp. Ex. 12 | 2700 | Sulfide solid electrolyte 3 | 2.0 | 50:50 | 1.18 |
| Comp. Ex. 13 | 510 | Sulfide solid electrolyte 4 | 4.3 | 60:40 | 0.79 |
| Comp. Ex. 14 | 510 | Sulfide solid electrolyte 4 | 4.3 | 50:50 | 0.73 |

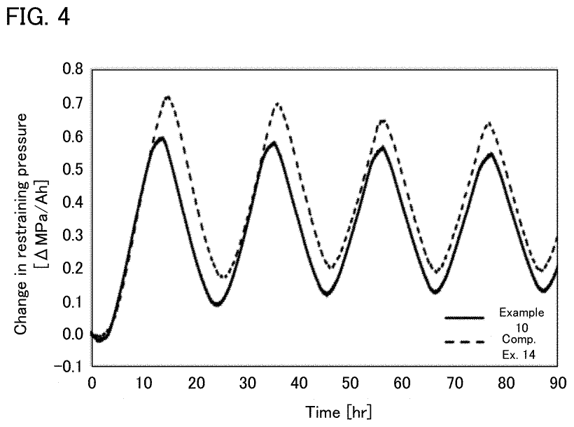

As shown in Table 2, Table 3, FIG. 2, and FIG. 3, the change in restraining pressure was small in Examples 1 to 12, in which the Si-based active material that was a nano material and the low crystalline sulfide solid electrolyte were respectively used. In contrast, as in Comparative Examples 1 to 12, the change in restraining pressure was large when the Si-based active material that was not a nano material and the low crystalline sulfide solid electrolyte were used. Further, although the Si particle size and the ratio of the active material and the solid electrolyte were the same in Example 5 and Comparative Example 13, the change in restraining pressure decreased when the low crystalline sulfide solid electrolyte was used. Similarly, when comparing Example 11 to Comparative Example 14, although the Si particle size was approximately the same, and the ratio of the active material and the solid electrolyte was the same, the change in restraining pressure decreased when the low crystalline sulfide solid electrolyte was used. Also, the chronological changes in restraining pressure of Example 10 and Comparative Example 14 are shown in FIG. 4. As shown in FIG. 4, the change in restraining pressure of Example 10 was smaller than that of Comparative Example 14.

### REFERENCE SIGNS LIST

1 anode current collector
2 anode active material layer
3 solid electrolyte layer
4 cathode active material layer
5 cathode current collector
10 all solid state battery

What is claimed is:

1. An all solid state battery comprising a cathode active material layer, an anode active material layer, and a solid electrolyte layer arranged between the cathode active material layer and the anode active material layer, wherein:
the anode active material layer includes a Si-based active material and a sulfide solid electrolyte;
an average particle size D₅₀ of the Si-based active material is 100 nm or more and 800 nm or less;
the sulfide solid electrolyte includes, in a Raman spectroscopy spectrum, a peak in a position of 415 cm⁻¹ or more and 425 cm⁻¹ or less, and a half-value width of the peak is 15.5 cm⁻¹ or more and 20.0 cm⁻¹ or less;
a volume ratio of the Si-based active material with respect to a total of the Si-based active material and the sulfide solid electrolyte is 1 volume % or more and 65 volume % or less; and
a volume ratio of the sulfide solid electrolyte with respect to the total of the Si-based active material and the sulfide solid electrolyte is 35 volume % or more and 99 volume % or less.

2. The all solid state battery according to claim 1, wherein:
the sulfide solid electrolyte contains a PS₄³⁻ structure; and
the peak is a peak of the PS₄³⁻ structure.

3. The all solid state battery according to claim 1, wherein the sulfide solid electrolyte contains at least Li, P, and S.

4. The all solid state battery according to claim 1, wherein the sulfide solid electrolyte contains a halogen.

5. The all solid state battery according to claim 1, wherein a lithium ion conductivity of the sulfide solid electrolyte at 25° C. is 1.5 mS/cm or more and 3.5 mS/cm or less.
